(19) United States
(12) Patent Application Publication
(10) Pub. No.: US 2011/0086778 A1
(43) Pub. Date: Apr. 14, 2011

(54) ENHANCED MICROPLATE CONFIGURATIONS

(76) Inventors: Mark G. Herrmann, Bountiful, UT (US); Tanya M. Sandrock, Salt Lake City, UT (US)

(21) Appl. No.: 12/902,080

(22) Filed: Oct. 11, 2010

Related U.S. Application Data
(60) Provisional application No. 61/251,178, filed on Oct. 13, 2009.

(51) Int. Cl. C40B 30/06; C40B 60/00; C40B 30/00

(52) U.S. Cl. 506/10; 506/33; 506/7

(57) ABSTRACT

An enhanced microplate can include a base having a footprint with a length of 5 127.76 mm±1 mm and a width of 85.48 mm±1 mm. The base can be configured for an array of microwells having a base being configured for an array of micro wells such that there are ax rows along the width and ∥bx∥ columns along the length, where a is 8 or 9, b is 12, 13 or 14 provided that when b is 12, a is 9, and x is 0.5 or a positive integer. These enhanced microplates can be used to effectively increase throughput, decrease analysis time, and can be readily integrated into existing systems.

### RELATED APPLICATIONS

The present application claims priority to U.S. Provisional Application No. 61/251,178, entitled ENHANCED MICROPLATE CONFIGURATIONS, filed Oct. 13, 2009, and which is incorporated herein in its entirety.

### BACKGROUND OF THE INVENTION

1. Field of the Invention

The present invention relates to systems and methods whereby to increase the efficiency and capacity of microplate devices. In particular, the present invention relates to microplate configurations which increase the sample capacity of a microplate while conserving dimensional standards of microplate as set by Society for Biomolecular Screening Society (SBS). The present invention further relates to retention systems whereby to control or preserve the position of a sample tube within a microplate device. Still further, the present invention relates to a system of interchangeable sample wells, wherein a dynamic microplate frame permits a user to selectively configure the microplate frame to include a desired sample well configuration.

2. Background and Related Art

Analytical systems provide a wide variety of tools for researchers and diagnostics. Miniaturization and automation of these analytical systems has allowed for dramatic increases in consistency, reliability and throughput. Among these systems, microplates are frequently used to provide an array of fluid samples to be tested. These microplates are used in a wide variety of equipment from fluid handlers, readers (e.g. fluorescence, fluorescence polarization, absorbance, luminescence), centrifuges, shakers, thermal cyclers, incubators, DNA sequencers, archives, cell and tissue culture, cell harvesters, illuminometer, mixers, radiometric counters, dispenser, washers, spectrometers, dispensers, replicators, evaporators, freezers, heaters, sealers, dryers, imagers, microscopes, photometers, microplate stackers and handlers, and the like.

Typical microplates have a standardized geometry and well configuration as promoted by ANSIISBS 4-2004. As early as the first meeting of the Society for Biomolecular Screening (SBS) in 1995, a need for clearly defined dimensional standards of a microplate was identified. At the time, the microplate was already becoming an essential tool used in drug discovery research. At the time, the concept of a microplate was similar among various manufacturers, but the dimensions of microplates produced by different vendors, and even within a single vendors catalog line varied. This often caused numerous problems when microplates were to be used in automated laboratory instrumentation.

In late 1995, members of the SBS began working on defining dimensional standards for the standard 96 well microplate. The first written proposal was released in December 1995 and presented at numerous scientific conferences and journals throughout 1996. This initial proposed standard was officially presented to the membership of SBS for approval at the annual meeting in October 1996 in Basel, Switzerland. Between then and late 1998, various versions of the proposed standards for 96 and 384 well microplates were circulated to the membership of the society. In early 1999, efforts to begin formalizing the proposed standards in preparation for submission to a recognized standards organization were begun. For several decades the arrangement of wells has been according to a 2:3 matrix of wells, such that the above ANSI publication has officially promoted and recognized these standards. Microplates having 6, 24, 96, 384 and 1536 wells are typical, although 3456 and 9600 well arrangements have also seen some limited use. The 8×12 array microplate is so accepted in the laboratory that when assays are developed little thought is given to the its consequences in most applications. For instance consider an assay where 96 samples or compounds are or can be archived, processed, or presented for analysis. To accommodate the need for standards and controls within the assay the samples are split to multiple plates thus incurring the cost of additional plate, reagents, standards, controls and time.

### SUMMARY OF THE INVENTION

The present invention addresses the inefficiencies present in current approaches to utilizing microplates in diagnostic and micro assays. An enhanced microplate in accordance with the present invention can include a base having a footprint with a length of 127.76 mm±1 mm and a width of 85.48 mm±1 mm. The base can be configured for an array of microwells having a base being configured for an array of micro wells such that there are ax rows along the width and ∥bx∥ columns along the length, where a is 8 or 9, b is 12, 13 or 14 provided that when b is 12, a is 9, and x is 0.5 or a positive integer.

A method of using these enhanced microplates can include introducing a plurality of fluid samples into the microwells. The plurality of fluid samples can be treated in accordance with known procedures (e.g. immunoassays, PCR, and the like). Once the treatment is performed, the remaining fluid can be subjected to an appropriate test to measure a desired property from which valuable information can be obtained.

There has thus been outlined, rather broadly, the more important features of the invention so that the detailed description thereof that follows may be better understood, and so that the present contribution to the art may be better appreciated. Other features of the present invention will become clearer from the following detailed description of the invention, taken with the accompanying drawings and claims, or may be learned by the practice of the invention.

### BRIEF DESCRIPTION OF THE DRAWINGS

In order that the manner in which the above-recited and other features and advantages of the invention are obtained will be readily understood, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is a perspective view of an enhanced 8×13 tube rack having 104 wells, in accordance with a representative embodiment of the present invention;

FIG. 2 is a perspective view of an enhanced 8×13 microplate having 104 wells and removable strip tube inserts along columns, in accordance with a representative embodiment of the present invention;

FIG. 3 is a perspective view of an enhanced 8×13 microplate having 104 wells, in accordance with a representative embodiment of the present invention;

FIG. 4 is a schematic view of a 28 well enhanced microplate, in accordance with a representative embodiment of the present invention;

FIG. 5 is a schematic view of a 104 well enhanced microplate, in accordance with a representative embodiment of the present invention;

FIG. 6 is a schematic view of a 416 well enhanced microplate, in accordance with a representative embodiment of the present invention; and

FIG. 7 is a schematic view of a 1664 well enhanced microplate, in accordance with a representative embodiment of the present invention.

### DETAILED DESCRIPTION OF THE INVENTION

While these representative embodiments are described in sufficient detail to enable those skilled in the art to practice the invention, it should be understood that other embodiments may be realized and that various changes to embodiments of the invention may be made without departing from the spirit and scope of the present invention. Thus, the following more detailed description of the embodiments of the present invention is not intended to limit the scope of the invention, as claimed, but is presented for purposes of illustration only and not limitation to describe the features and characteristics of the present invention, to set forth the best mode of operation of the invention, and to sufficiently enable one skilled in the art to practice the invention. Accordingly, the scope of the present invention is to be defined solely by the appended claims.

In describing and claiming the present invention, the following terminology will be used:

The singular forms “a”, “an”, and “the” include plural referents unless the context clearly dictates otherwise. Thus, for example, reference to “a well” includes reference to one or more of such features and reference to “treating” refers to one or more such steps.

As used herein with respect to an identified property or circumstance, “substantially” refers to a degree of deviation that is sufficiently small so as to not measurably detract from the identified property or circumstance. The exact degree of deviation allowable may in some cases depend on the specific context.

As used herein, “adjacent” refers to the proximity of two structures or elements. Particularly, elements that are identified as being “adjacent” may be either abutting or connected. Such elements may also be near or close to each other without necessarily contacting each other. The exact degree of proximity may in some cases depend on the specific context.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Any steps recited in any method or process claims may be executed in any order and are not limited to the order presented in the claims. Means-plus-function or step-plus-function limitations will only be employed where for a specific claim limitation all of the following conditions are present in that limitation: a) “means for” or “step for” is expressly recited; and b) a corresponding function is expressly recited. The structure, material or acts that support the means-plus function are expressly recited in the description herein. Accordingly, the scope of the invention should be determined solely by the appended claims and their legal equivalents, rather than by the descriptions and examples given herein.

### Representative Embodiments

An enhanced microplate can include a base having a footprint with a length of 127.76 mm±1 mm and a width of 85.48 mm±1 mm. The base can be configured for an array of microwells such that there are ax rows along the width and ∥bx∥ columns along the length, wherein a is 8 or 9, b is 12, 13 or 14 provided that when b is 12, a is 9, and x is 0.5 or a positive integer.

Although the range can vary, x is typically 0.5, 1, 2, 4, 6 or 10. In one specific aspect x is 1. However, any integer can be useful, although currently useful embodiments are up to x is 10. Table I provides an outline of the array configurations for the 8:13 configurations for various x values and a comparison with 2:3 arrangements.

TABLE I

| x | 2:3 Matrix | 2:3 Wells | 8:13 Matrix | 8:13 Wells |
|---|---|---|---|---|
| 0.5 | 4 × 6 | 24 | 4 × 7 | 28 |
| 1 | 8 × 12 | 96 | 8 × 13 | 104 |
| 2 | 16 × 24 | 384 | 16 × 26 | 416 |
| 3 | 24 × 36 | 864 | 24 × 39 | 936 |
| 4 | 32 × 48 | 1536 | 32 × 52 | 1664 |
| 5 | 40 × 60 | 2400 | 40 × 65 | 2600 |
| 6 | 48 × 72 | 3456 | 48 × 78 | 3744 |
| 7 | 56 × 84 | 4704 | 59 × 91 | 5096 |
| 8 | 64 × 96 | 6144 | 64 × 104 | 6657 |
| 9 | 72 × 108 | 7776 | 72 × 117 | 8424 |
| 10 | 80 × 120 | 9600 | 80 × 130 | 10400 |

*Not all of the 2:3 configurations listed above are currently used.

As can be appreciated from Table I each of the 8:13 configurations provides an 8.3% increase in the number of available wells (except for x=0.5 which is a 16.7% increase). Thus, the 8:13 matrix microplates provide an 8.3% increase in absolute throughput for a set number of microplate runs through any given equipment. Further, a can also be 9 such that 9×12, 9×13 and 9×14 matrix arrays can be achieved. For example, in the case of x=1 these 9×b arrays would have 108, 117 and 126 wells respectively. In these cases, the percent increase in throughput relative to the standard 96 well microplate plate goes up (e.g. 12.5%, 21.9% and 31.25%, respectively). These increases do not include process efficiencies realized by avoiding the use of additional microplates for controls and reference samples.

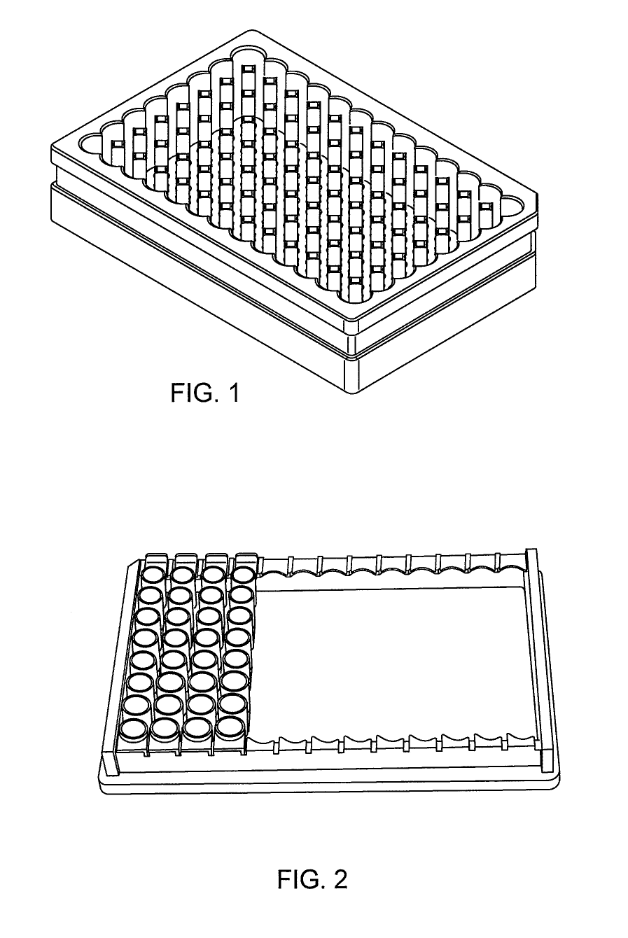

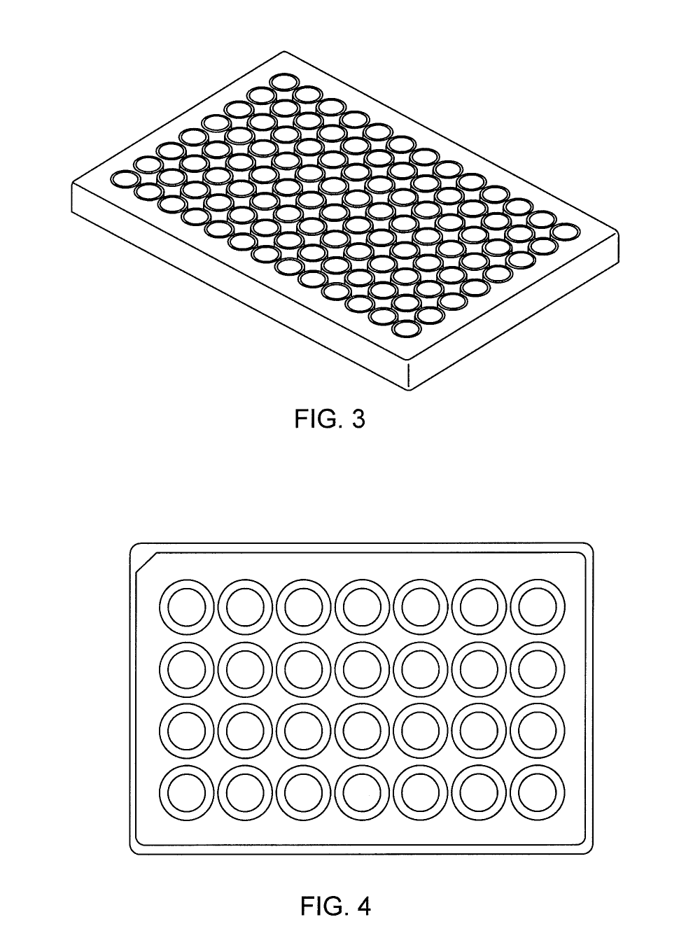

FIG. 1 illustrates a 104 well microplate having recesses configured to hold tube inserts. In this case, the recesses are overlapping so that open areas are interconnected with pillars at intersections between four neighboring tube positions. The array of microwells can be integrated with the base. Alternatively, FIG. 2 illustrates a base having removable strip tube holders (shown with a single strip in place). The base with removable strips can include notched recesses to receive the strip of a column segment having ax microwells therein. Regardless of the upper configuration, the base can optionally have a flange (e.g. a 1.27 mm flange width). Further, the base can be configured to act as actual test wells or to hold individual micro tubes as illustrated in FIG. 3.

The test wells can be provided in a number of configurations. In one aspect, the test wells are PCR wells or deep wells. Typically, when the test wells are integrated into the base the microplate is designed as a single use disposable unit, although they can be washed to remove hazardous material or recover valuable material. In another aspect, the array of microwells is configured as recesses to hold tube inserts. In one optional aspect, the recesses are open-bottom, i.e. through holes for the incorporation of filters or extraction columns. In another aspect the microwells can be opaque, translucent or transparent to enhance the detection. The microwells can be provided in a wide variety of shapes depending on the particular application. Non-limiting examples of well shapes include cylindrical shape, tapered conical shape, round bottom shape, or incorporate special features that enhance a specific process and the like.

The orientation of microwells in the array can be arranged in any suitable spacing. However, most often the micro wells are uniformly spaced along a grid pattern. The pitch can be varied and is most often 18, 9, 4.5, 2.25, 1.125 or 0.50625 mm.

The enhanced microplate can provide additional columns and/or rows which can be used to increase the number of active unknown samples or as standards or references. In one aspect, one column of the array of micro wells is designated for standards or references.

The enhanced microplates have the same footprint as conventional microplates. This facilitates using existing equipment without structural modification in most cases. Typically, all that is required for effective use of the enhanced microplate is to program the software running the equipment to recognize the change in location and number of wells. However, PCR thermal cyclers also have a thermal block which keeps the wells uniformly heated via the Peltier heaters. Thus, complimentary block heaters can be formed to allow the enhanced microplates to be inserted into the PCR thermal cycler units.

A method of using these enhanced microplates can include introducing a plurality of fluid samples into the microwells. The plurality of fluid samples can be treated in accordance with known procedures (e.g. immunoassays, radioimmunoassay, enzymatic assays, colorimetric assays, solid phase extraction, ELIZA, tissue and cell culture, PCR, and the like). Once the treatment is performed, the remaining fluid can be subjected to an appropriate test to measure a desired property from which valuable information can be obtained.

The plurality of fluid samples can include a plurality of unknown samples, a plurality of reference samples, and plurality of standard samples. Non-limiting examples of analysis that can be performed using the enhanced microplates include Molecular Genetics assays such as Factor V, Prothrombin, molecular sequencing and fragment analysis assays such as fragile X and Huntington's disease. Infectious disease assays such as HIV quantization, radioimmmuno assays such as vitamin D 1, 25, Eliza and other immuno assays such as Heliobacter Pylori, flow cytometry assays such as CD4/CD8.

### EXAMPLES

Unless otherwise specified, all dimensions are applicable at 20 degrees C. (68 degrees F.). Compensation may be made for measurements made at other temperatures. ASME YI4.5M-1994, dimensioning and tolerancing are also used throughout these examples. The base footprint is as defined by SBS ANSI/SBS 1-2004, height dimensions are defined by SBS ANSI/SBS 2-2004, height can range from 0.15 to 150 mm, and the bottom flange is defined by SBS ANSI/SBS 3-2004. However, these are not limited to flange or flangeless designs.

### 28-Well Microplate

FIG. 4 shows the layout having wells in a 28 well microplate arranged as four rows by seven columns. The distance between the left outside edge of the plate and the center of the first column of wells is 9.88 mm (0.3890 inches). The left edge of the part will be defined as the two 12.7 mm areas (as measured from the corners) as specified in SBS-1. Each following column shall be an additional 18 mm (0.7087 inches) in distance from the left outside edge of the plate. The distance between the top outside edge of the plate and the center of the first row of wells is 15.74 mm (0.6197 inches). The top edge of the part will be defined as the two 12.7 mm areas (as measured from the corners) as specified in SBS 1. Each following row shall be an additional 18 mm (0.7087 inches) in distance from the top outside edge of the plate. The positional tolerance of the well centers will be specified using so called “True Position”. The center of each well will be within a 0.70 mm (0.0276 inches) diameter of the specified location. This tolerance will apply at “RFS” (regardless of feature size).

### 104-Well Microplate

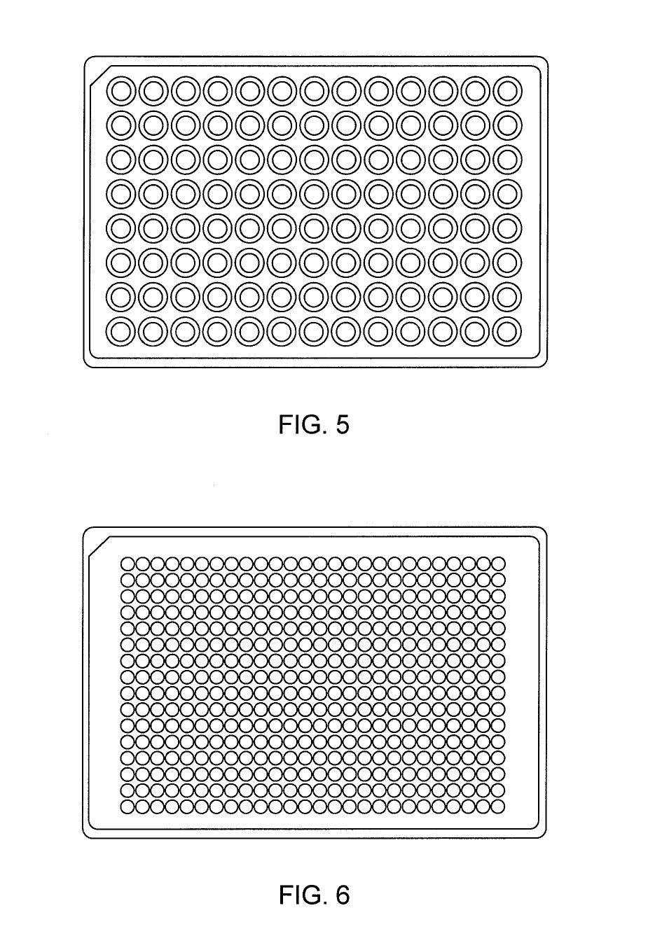

FIG. 5 shows wells in a 104 well microplate arranged as eight rows by thirteen columns. The distance between the left outside edge of the plate and the center of the first column of wells is 9.88 mm (0.3890 inches). The left edge of the part is defined as the two 12.7 mm areas (as measured from the corners) as specified in SBS-1. Each following column shall be an additional 9.0 mm (0.3543 inches) in distance from the left outside edge of the plate. The distance between the top outside edge of the plate and the center of the first row of wells shall be 11.24 mm (0.4425 inches). The top edge of the part is defined as the two 12.7 mm areas (as measured from the corners). Each following row shall be an additional 9 mm (0.3543 inches) in distance from the top outside edge of the plate. The positional tolerance of the well centers is specified using so called “True Position”. The center of each well is within a 0.70 mm (0.0276 inches) diameter of the specified location. This tolerance will apply at “RFS” (regardless of feature size).

### 416 Well Microplate

FIG. 6 shows wells in a 384 well microplate should be arranged as sixteen rows by twenty-six columns. The distance between the left outside edge of the plate and the center of the first column of wells shall be 7.63 mm (0.3004 inches). The left edge of the part will be defined as the two 12.7 mm areas (as measured from the corners) as specified in SBS-1. Each following column shall be an additional 4.5 mm (0.1772 inches) in distance from the left outside edge of the plate. The distance between the top outside edge of the plate and the center of the first row of wells shall be 8.99 mm (0.3539 inches). The top edge of the part will be defined as the two 12.7 mm areas (as measured from the corners) as specified in SBS-1. Each following row shall be an additional 4.5 mm (0.1772 inches) in distance from the top outside edge of the plate. The positional tolerance of the well centers will be specified using so called “True Position”. The center of each well will be within a 0.70 mm (0.0276 inches) diameter of the specified location. This tolerance will apply at “RFS” (regardless of feature size).

### 1664 Well Microplate

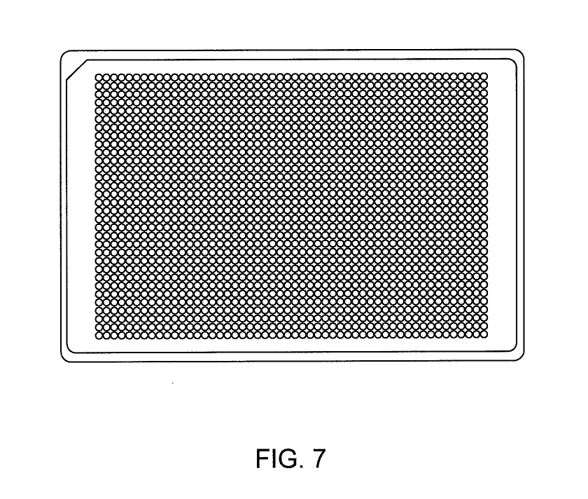

FIG. 7 shows wells in a 1664 well microplate should be arranged as thirty-two rows by fifty-two columns. The distance between the left outside edge of the plate and the center of the first column of wells shall be 6.38 mm (0.2512 inches). The left edge of the part will be defined as the two 12.7 mm areas (as measured from the corners) as specified in SBS-1. Each following column shall be an additional 2.25 mm (0.0886 inches) in distance from the left outside edge of the plate. The distance between the top outside edge of the plate and the center of the first row of wells shall be 7.865 mm (0.3096 inches). The top edge of the part will be defined as the two 12.7 mm areas (as measured from the corners) as specified in SBS-1. Each following row shall be an additional 2.25 mm (0.0886 inches) in distance from the top outside edge of the plate. The positional tolerance of the well centers will be specified using so called “True Position”. The center of each well will be within a 0.50 mm (0.0197 inches) diameter of the specified location. This tolerance will apply at “RFS” (regardless of feature size).

### Example 1

Chemical and molecular screening library store the samples in 96 well formats. When it comes to analysis some samples are removed to accommodate standards and controls. These “extra” samples are run on a different plate. In this instance the mother daughter plate mapping is lost and sample analysis testing becomes staggered. If a 104 plate is used then all analytes can be run simultaneously with mother daughter plate maps unbroken.

### Example 2

Molecular genetics assays are comprised of two processes, DNA extraction and analysis. Both process use instrumentation capable with 96 well microplates. In order to analyze 96 wells 88 samples must be extracted. Thus the extractor is running at 91.7% through put. If the extractor process 96 samples then only 88 can be run due to the incorporation of standards controls and occasional repeats. Thus the analyzer is operating only at 91.7% throughput.

### Example 3

Automated radioimmunoassays have additional tubes to determine total radioactive count and count due to nonspecific binding. These factors plus the standard curve are used to quantify the specimen's analyte. If specimen standards and controls are processed in a 96 well format two options exist for automating. The first is to reduce the sample number to accommodate the later addition of total count and nonspecific binding tubes and down steam processing is undisturbed. The second is to add additional plates to accommodate the total count and nonspecific binding tubes. This option increases the time spent on downstream process such as centrifugation which will require multiple spins due to microplate centrifuges only hold 2 heavy micro plates. The 104 plate takes advantage of both options in that it can accommodate the 96 sample processing, total count and non specific binding tubes as well as downstream processing of reduced samples due to all tubes being constrained within the microplate format.

The foregoing detailed description describes the invention with reference to specific representative embodiments. However, it will be appreciated that various modifications and changes can be made without departing from the scope of the present invention as set forth in the appended claims. The detailed description and accompanying drawings are to be regarded as merely illustrative, rather than as restrictive, and all such modifications or changes, if any, are intended to fall within the scope of the present invention as described and set forth herein.

What is claimed is:

1. An enhanced microplate, comprising:
a base having a footprint with a length of 127.76 mm±1 mm and a width of 85.48 mm±1 mm, said base being configured for an array of microwells such that there are ax rows along the width and ∥bx∥ columns along the length, wherein a is 8 or 9, b is 12, 13 or 14 provided that when b is 12, a is 9, and x is 0.5 or a positive integer.

2. The enhanced microplate of claim 1, wherein x is at least one of 0.5, 1, 2, 4, 6 and 10.

3. The enhanced microplate of claim 1, wherein x is 1.

4. The enhanced microplate of claim 1, having a row:column ratio of 8:13.

5. The enhanced microplate of claim 1, wherein the array of micro wells is integrated with the base.

6. The enhanced microplate of claim 1, wherein the array of micro wells is configured as test wells.

7. The enhanced microplate of claim 5, wherein the test wells are thermally compatible for a range of temperatures for iso and cyclic thermal reactions.

8. The enhanced microplate of claim 5, wherein the test wells are deep wells.

9. The enhanced microplate of claim 1, wherein the array of microwells is configured as recesses to hold tube inserts.

10. The enhanced microplate of claim 8, wherein the recesses are open-bottom.

11. The enhanced microplate of claim 1, wherein the array of micro wells is removable from the base.

12. The enhanced microplate of claim 10, wherein the base includes notched recesses to receive a column segment having ax microwells therein.

13. The enhanced microplate of claim 1, wherein the base further includes a flange.

14. The enhanced microplate of claim 1, wherein the microwells are a cylindrical shape.

15. The enhanced microplate of claim 1, wherein the micro wells are a tapered conical shape.

16. The enhanced microplate of claim 1, wherein the microwells are uniformly spaced along a grid pattern.

17. The enhanced microplate of claim 1, wherein the microwells have a pitch of 18, 9, 4.5, 2.25, 1.125 or 0.50625 mm.

18. The enhanced microplate of claim 1, wherein at least one column or one row of the array of microwells is designated for standards or references.

19. A heat transfer block having heated recesses to receive the enhanced microplate of claim 1.

20. The heat transfer block of claim 19, wherein the block is configured for use as a PCR block heater, isothermal heater, or isothermal chiller.

21. A method of using the enhanced microplate of claim 1, comprising:
a) introducing a plurality of fluid samples into the microwells;
b) treating the plurality of fluid samples; and
c) measuring a property of the fluid samples.

22. The method of claim 21, wherein the plurality of fluid samples include at least one of a plurality of unknown samples, a plurality of reference samples, and a plurality of standard samples.

23. The method of claim 21, wherein the treating is selected from the group consisting of immunoassay, polymerase chain reaction, vitamin D assay, and heliobacter pylori assay.
